(19) United States
(12) Patent Application Publication
(10) Pub. No.: US 2005/0075810 A1
(43) Pub. Date: Apr. 7, 2005

(54) Spectral jitter analysis allowing jitter modulation waveform analysis

(75) Inventor: Bernd Laquai, Stuggart (DE)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Agilent Technologies, Inc.

(21) Appl. No.: 10/911,204

(22) Filed: Aug. 4, 2004

(30) Foreign Application Priority Data
Aug. 20, 2003 (EP) EP03103205.5

(51) Int. Cl. G06F 19/00

(52) U.S. Cl. 702/69

(57) ABSTRACT

For providing a jitter analysis for a signal, a jitter spectrum derived from the signal is filtered, so that the filtered jitter spectrum substantially only comprises one or more deterministic spectral components identified as being expected to result from a deterministic jitter component in the signal resulting from a deterministic and non-random cause. A jitter modulation signal is derived by transforming the filtered identified one or more deterministic spectral components into the time domain, wherein the jitter modulation signal represents a deterministic jitter signal modulated on the signal.

### BACKGROUND OF THE INVENTION

The present invention relates to jitter analysis for signals.

Characterization of the transient behavior of high-speed digital circuits, i.e. the transition from a logical zero to a logical one and vice versa, has become increasingly important for designing as well as manufacturing such digital circuits. Timing instabilities such as jitter can cause single transmission errors, or temporary or even permanent outage of an entire communication system, and have to be avoided. The standard overall figure of merit for a communications system is the Bit Error Rate (BER), however a high value of BER does not necessarily indicate timing problems, as there are many other potential sources of error in a system (for example level/threshold mismatch).

One of the key specifications of high-speed circuits with respect to timing is Jitter. ITU-T G.701 defines jitter as short-term non-cumulative variations of the significant instants of a digital signal from their ideal positions in time. The significant instant can be any convenient, easily identifiable point on the signal such as the rising or falling edge of a pulse or the sampling instant. By plotting the relative displacement in the instants between an ideal pulse train and a real pulse train that has some timing jitter, the so-called jitter function is obtained. In addition to the jitter time function, the jitter spectrum can be displayed in the frequency domain. Jitter can also be displayed using so-called Jitter-Histograms showing the likelihood for a transition.

Jitter histograms can be measured using e.g. an oscilloscope, a time interval analyzer, or a BER Tester. The applicant Agilent Technologies provides various BER test equipment such as the Agilent® 81250 ParBERT®. Histogram values are obtained from a BER vs. Sample Delay measurement (generally referred to as the so-called bathtub curve) by taking the absolute value of the derivative.

Various ways for jitter analysis are disclosed in the EP-A-1265391 by the same applicant, the teaching thereof shall be incorporated herein by reference. International Patent Application PCT/EP02/0484, by the same inventor and applicant, discloses spectral jitter analysis—the teaching thereof shall be incorporated herein by reference.

### SUMMARY OF THE INVENTION

It is an object of the invention to provide an improved jitter analysis. The object is solved by the independent claims. Preferred embodiments are shown by the dependent claims.

For providing a jitter analysis for a signal, a jitter spectrum derived from the signal is filtered, so that the filtered jitter spectrum substantially only comprises one or more deterministic spectral components identified as being expected to result from a deterministic jitter component in the signal resulting from a deterministic and non-random cause. A jitter modulation signal is derived by transforming the filtered identified one or more deterministic spectral components into the time domain, wherein the jitter modulation signal represents a deterministic jitter signal modulated on the signal.

Various alternatives or combinations thereof can be applied for identifying deterministic spectral components in the jitter spectrum: one or more threshold values may be applied, and the spectral components are identified when exceeding one or more of the threshold values. Harmonic frequencies belonging to one or more fundamental frequencies might be evaluated. Spectral peaks can be identified that follow a given pattern and/or a sequence on the frequency axis. A-priori knowledge on the periodicity of an expected jitter modulation signal can be used to identify the deterministic spectral components at expected frequencies taking into account particularly harmonic frequencies belonging to a fundamental frequency of the expected jitter modulation signal. Search algorithms may be applied on the spectral components of the obtained jitter spectrum to identify spectral peaks that follow a given pattern or sequence on the frequency axis. Spectral components with substantially non-random energy content, with energies exceeding a certain value, at specific known frequencies, following a given sequence of pattern, in a certain frequency band, etc. may be selected.

In case that plural jitter modulation signals are present or at least expected to be present, determined deterministic spectral components can be assigned to groups of deterministic spectral components, wherein each group of deterministic spectral components is related to a different deterministic jitter modulation signal. Defining a group of deterministic spectral components might be accomplished by various alternatives or combinations thereof e.g.: by harmonic relationship, wherein the determined deterministic spectral components in that group have harmonic frequencies belonging to a fundamental frequency; by frequency range, wherein the determined deterministic spectral components in that group have frequencies within that frequency range; by individual shaping, wherein each determined deterministic spectral component in the individual group has a given shaping; group shaping, wherein the determined deterministic spectral components in that group have a given shaping determined by at least one of: frequency distribution of phase and magnitude, amplitude waveform in the time domain.

Filtering may be provided e.g. by the following alternatives or combinations thereof: passing only the spectral content at selected frequencies and discarding the others, amplifying only the spectral content at the selected frequencies, attenuating the spectral content at the not selected frequencies. Filtering is preferably done in the frequency domain but equivalent time domain filters can be applied accordingly.

The jitter spectrum preferably represents the spectral components of jitter determined for the signal, preferably in the frequency domain. The jitter spectrum can be obtained by deriving an error signal, preferably a binary error signal, from the signal, and deriving the jitter spectrum from the error signal, preferably by providing a transformation into the frequency domain. Alternatively or in combination thereto, the error signal can be derived by comparing the signal with a reference signal at a plurality of different timing points.

According to one embodiment, a jitter analysis is provided for a signal to be measured having transitions between logical levels. At each of a plurality of successive timing points, a detection of the signal at that timing point is provided. The result of the detection is compared with a reference signal, and an error value is derived therefrom for each timing point. Each error value represents a matching information between a detected transition (or non-transition) and an expected transition (or non-transition) for the respective timing point.

An error signal is then provided representing the derived error values relative to its respective timing points, or in other words, the error signal represents the plurality of the derived error values, each error value being associated with its respective timing point. The error signal thus shows the variation of the error values, with the variation might be provided over the time (absolute or relative time scale) or any other scale derived from the timing points. Thus, the error signal can be e.g. the derived error values over the plurality of successive timing points. Instead of the plurality of successive timing points, other bases of the error values in the error signal can be derived from the plurality of successive timing points, such as an absolute or relative time scale. Accordingly, a pseudo time scale can be provided with the plurality of successive timing points as successive events independent of the actual time difference between successive events. This is in particular useful in case the error values are sampled periodically.

A spectral jitter processing is then deployed to the error signal in order to detect spectral components in the error signal and/or to derive the jitter spectrum, which might represent relevant spectral information of jitter contained in the signal. It will be appreciated that substantially any known method for spectral processing can be applied for the spectral jitter analysis of the error signal, such as auto-correlation, cross-correlation, Fourier-Analysis, etc. Preferred examples for spectral analysis are disclosed e.g. in A. Papoulis: Probability, Random Variables and Stochastic Processes, McGraw Hill 1965, or in J. S. Bendat: A. G. Piersol, Random Data, John Whiley & Sons, 1986. It goes without saying that the specific context of different measurements might render one or more of the known spectral analysis method more or less applicable.

Embodiments of the invention thus allow analyzing the signal for spectral components resulting from jitter influences, deriving the jitter spectrum, and/or deriving jitter modulation signals modulated on the signal. Identified spectral components might then be applied for taking further actions e.g. to avoid or reduce jitter at specific frequencies or for quality checks. Preferred examples are evaluating quantitative presence of known spectral jitter components in the signal or a pass/fail test if one or more such known spectral jitter components exceed one or more given thresholds. Accordingly, the knowledge about detected jitter modulation signals can be applied to find and reduce or eliminate causes of the jitter modulation. Quantitative evaluations of jitter modulation signals in the signal, or a pass/fail test (if one or more such jitter modulation signals exceed one or more given thresholds) might result.

The timing points for detecting transitions in the signal are preferably selected in ranges wherein transitions are likely (e.g. under the influence of jitter). Preferably, timing points are selected substantially in the middle of such range wherein transitions are likely under the influence of jitter. Such transition ranges can be determined e.g. using known techniques such as the aforementioned jitter histograms, bit error rate (BER) measurements, or eye diagram measurements, etc.

In a preferred embodiment wherein transitions in the signal are related to a reference signal (e.g. a clock signal) having a reference frequency, the distance between successive timing points is preferably derived from the reference frequency (e.g. as the period, or multiples or fraction thereof, of the reference frequency). The timing points are preferably selected at timings when transitions are expected without influence of jitter, preferably in the middle of a transition area as e.g. determined using an aforementioned eye-diagram.

The transition detection is possible in various ways, preferably by detecting the signal value at a level threshold at a given reference timing point (BER test equipment) or by evaluating the sampled signal waveform (Oscilloscope).

The reference signal is preferably one of: an expected signal substantially representing the signal expected to receive (as used e.g. in EP-A-1241483 by the same applicant), an expected signal substantially representing a data content of the signal expected to receive, a signal derived from the signal, a digital signal derived from the signal (as used e.g. in European Patent Application No. 02017333.2 by the same applicant), a constant signal, an arbitrary test signal (as used e.g. in International Patent Application No. WO/EP03/50365 by the same applicant), etc. Preferred alternatives for the arbitrary test signal are: a signal independent of the digital data signal, a signal unrelated to data content of the digital data signal, a signal non-correlated to the digital data signal, a signal with no deterministic relationship with the digital data signal, a signal independent of the digital data signal, an arbitrary test value, a fixed logic value, preferably one of a logic HIGH and a logic LOW signal, one logic level of the digital data signal, a pseudo random binary sequence PRBS, an alternating signal, a signal of alternating logic values, preferably alternating between a logic HIGH and a logic LOW signal.

The signal can by any kind of signal to be tested such as a digital signal having transitions between logical levels, or an analogue signal, etc.

The invention can be partly or entirely embodied or supported by one or more suitable software programs, which can be stored on or otherwise provided by any kind of data carrier, and which might be executed in or by any suitable data processing unit. The invention may also be partly or entirely embodied or supported by dedicated electronic hardware not related to software or firmware execution such as a hardwired ASIC. Accordingly, combinations of software and hardware solutions might also be employed.

### BRIEF DESCRIPTION OF THE DRAWINGS

Other objects and many of the attendant advantages of the present invention will be readily appreciated and become better understood by reference to the following detailed description when considering in connection with the accompanied drawings. Features that are substantially or functionally equal or similar will be referred to with the same reference sign(s).

FIGS. 1-2 illustrate the effect of sinusoidal jitter modulation onto a random digital data signal and the resulting error signal.

FIG. 3 shows an example of an embodiment according to the present invention.

FIGS. 4-7 illustrate the effect of jitter modulation and random jitter content onto a random digital data signal, the resulting error signal the jitter spectra, and the extracted jitter modulation waveform.

FIG. 8 illustrates the influence of the position of the sampling point.

### DETAILED DESCRIPTION OF EMBODIMENTS OF THE INVENTION

For validation and characterization of digital circuit designs, it is of advantage not only to quantify the amount of jitter measured but also to analyze it for its spectral content to localize its origin and/or analyze the time dependent waveform and amplitude and to understand the mechanisms of interference. In order to allow elimination or reduction of deterministic jitter in a design, the generated jitter is analyzed for its deterministic content by decomposing it into its spectral contents and/or extract the deterministic content using a frequency selective filtering of an error signal obtained from comparing the digital data signal. Whereas the energy of random jitter modulation is generally spread into wide frequency band, deterministic jitter usually manifests itself with a concentration of energy into (e.g. a few) discrete modulation frequencies. The ability to determine those frequencies and/or extract the jitter waveform of the deterministic content might provide insight into root causes and allows quantification of the deterministic jitter. It can therefore significantly speed up the debugging process.

In the following, preferred embodiments are described for providing spectral analysis on jitter and/or jitter modulation analysis using a bit error rate tester (BERT) such as the aforementioned Agilent® 81250 ParBERT®. However, it is clear that the invention is not limited to BERTs, but that any other test equipment can be provided for deriving the error signal from comparing detected with expected transitions at defined timing points or sampling and evaluating the entire signal waveform.

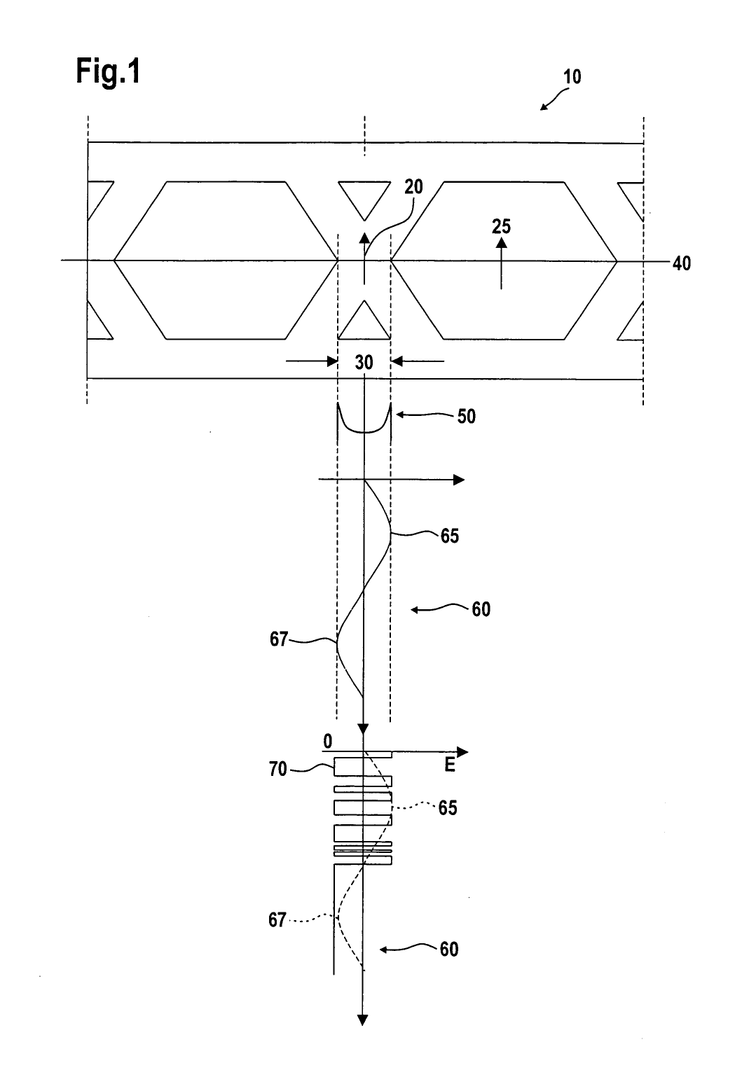

For explaining principles of embodiments of the present invention, FIG. 1 illustrates in an example the effect of a purely sinusoidal jitter modulation onto a random digital data signal. It is noted that the invention can also be applied on other types of signal, such as analog signals, and is not limited to random signals. However, in order to demonstrate effects of inventive embodiments, random digital data signal have been shown to be of advantage.

The upper part of FIG. 1 shows a typical eye diagram 10 with a plurality of transitions superimposed. For the sake of clarity, only the ‘borders’ of superimposed lines are shown. In this example, a sampling point 20 is selected to be within a transition range 30 determined by all detected transitions occurring at a given threshold level 40. Preferably, the sampling point 20 is selected substantially in the middle of the transition range 30 for a given threshold level 40 of substantially 50%. The sampling point 20 might also be selected using a Jitter Histogram 50, and is preferably selected at the center of gravity of the Jitter Histogram 50.

At the sampling point 20, strobing is provided by comparing each detected signal value with the value expected in the ‘center’ of the data eye (e.g. in the eye to the right, indicated by a reference timing point 25). Whenever a transition is displaced such that the data eye closes (displacement to the right in the eye diagram 10 of FIG. 1), the strobing will result in an error.

For the sake of better understanding, a sinusoidal jitter modulation 60 onto a random digital data signal shall be assumed. While the random data signal allows an easier explanation, it is clear that the invention can be applied for any kind of signal. Without the jitter modulation 60, all transitions of the digital data signal would occur precisely at the sampling point 20. However, the jitter modulation 60 will periodically displace the transitions of the digital data signal ‘around’ the sampling point 20, thus leading to the transition range 30. Just from looking at the jitter histogram 50, no conclusion can be made on the frequency of the jitter modulation 60.

Whenever the jitter modulation 60 displaces the transitions to the right in FIG. 1 and comparison is performed e.g. to the value as expected at the reference timing point 25 of the right data eye center, the strobing will result in errors. Due to the displacement of the transitions, the value of the left data bit is actually compared to what is expected at the reference timing point, thus resulting in an error.

Since we assume random data, the BER will be 0.25, because in 50% of the cases during the positive portion 65 of the jitter modulation sine wave 60 adjacent bits are equal in value and no transition will occur between the sampled and the expected bit. Thus, the jitter has no impact on that particular bit. In contrary, when the displacement is opposite (i.e. during the negative portion 67 of the jitter modulation sine wave 60 no error will occur. No error occurs, because the data eye to the right is opened by the displacement (displacement to the left in FIG. 1), which allows to sample the expected value despite the offset of the current sampling point 20 to the reference data point 25. Thus, the error signal 70 (with the errors E depicted over the time) is modulated in its error density according to the jitter frequency of the jitter modulation 60.

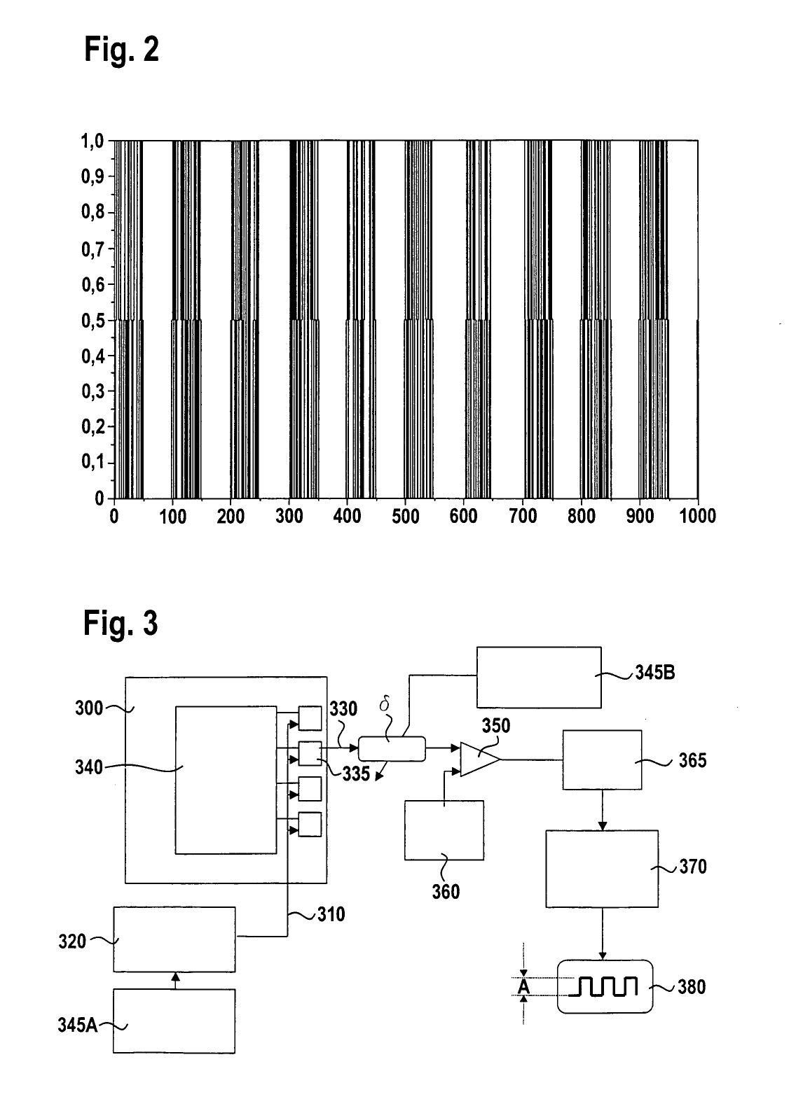

FIG. 2 shows an example of the result of a simulation of what is shown schematically in FIG. 1. FIG. 2 represents the logical values (represented by 0 and 1) of the generated error signal 70 over the time. The error signal 70 shows a periodic modulation of the error density. The periodicity appears as a segment with zero errors followed by a segment with 50% errors.

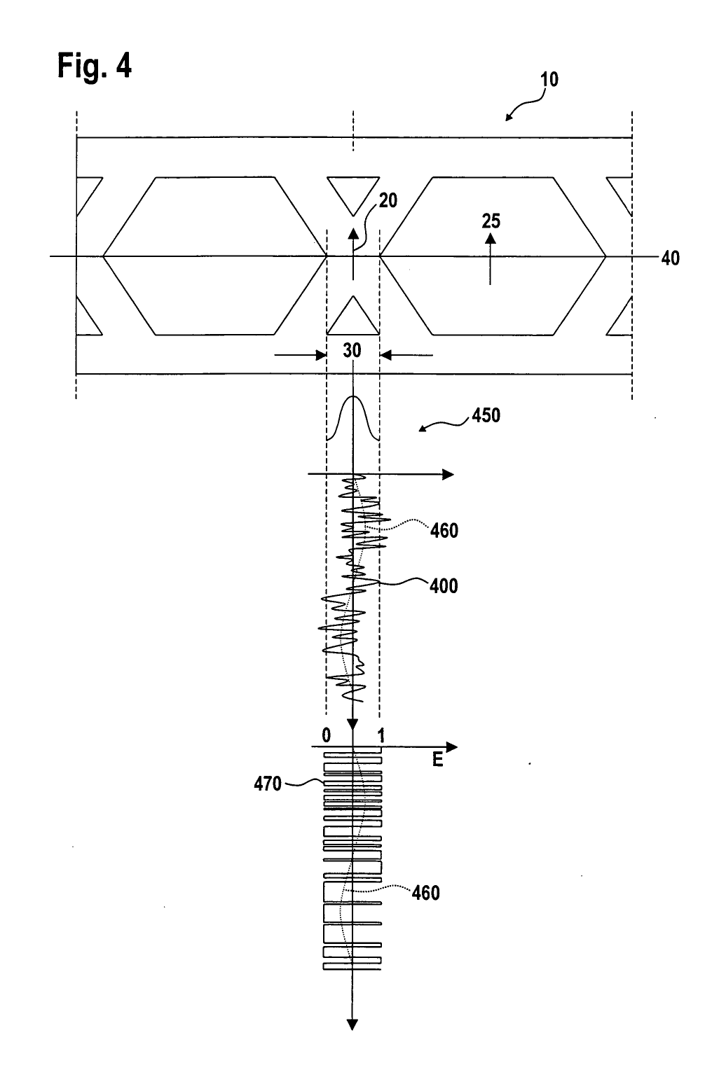

FIG. 3 depicts an embodiment for executing jitter analysis as illustrated for FIGS. 1-2. A device under test (DUT) 300 receives a clock signal 310 from a clock generator 320 and provides an output signal 330 at one or more output ports. In the example of FIG. 3, the clock signal 310 is applied to a plurality of input/output (IO) cells 335, each of those receiving data signals (e.g. at lower data rate in parallel) from a digital core 340 of the DUT 300 and output the data (e.g. serially at high data rate). The digital core 340 represents the plurality of digital and optionally analog processing units in a highly integrated and complex system-on-a-chip device.

In order to allow the analysis of deterministic jitter in either the frequency or modulation time domain the presence of either intrinsic random jitter or intentionally injected auxiliary jitter of known characteristic is advantageous. In case the intrinsic jitter is not sufficient to achieve a quantified analysis, auxiliary jitter, preferably random jitter of high bandwidth or sinusoidal jitter of known frequency, might be injected. In the example of FIG. 3, this can be done either through the reference clock generator 320 using phase modulation and a modulation source 345A, or through a jitter injection unit δ coupled to the output signal 330 and using a modulation source 345B (which can be substantially the same as the noise generator 345A).

A comparator 350 receives the output signal 330 (with or without additional jitter modulation), compares the received signal against a reference signal 360 at respective sampling points, and provides as output e.g. the error signal E as depicted in the lower part of FIGS. 1 and 4. The existence of either the intrinsic random jitter generated in the DUT 300 itself or the auxiliary jitter injected intentionally as described above causes the output signal 330 that is compared against a reference signal 360 in the comparator 350 to vary across the compare threshold of the comparator 350 and thus transferring the deterministic jitter content into a density modulation of the error signal at the output of the comparator. However, it is noted that the auxiliary jitter injection is only optional and provides certain advantages as will be illustrated later.

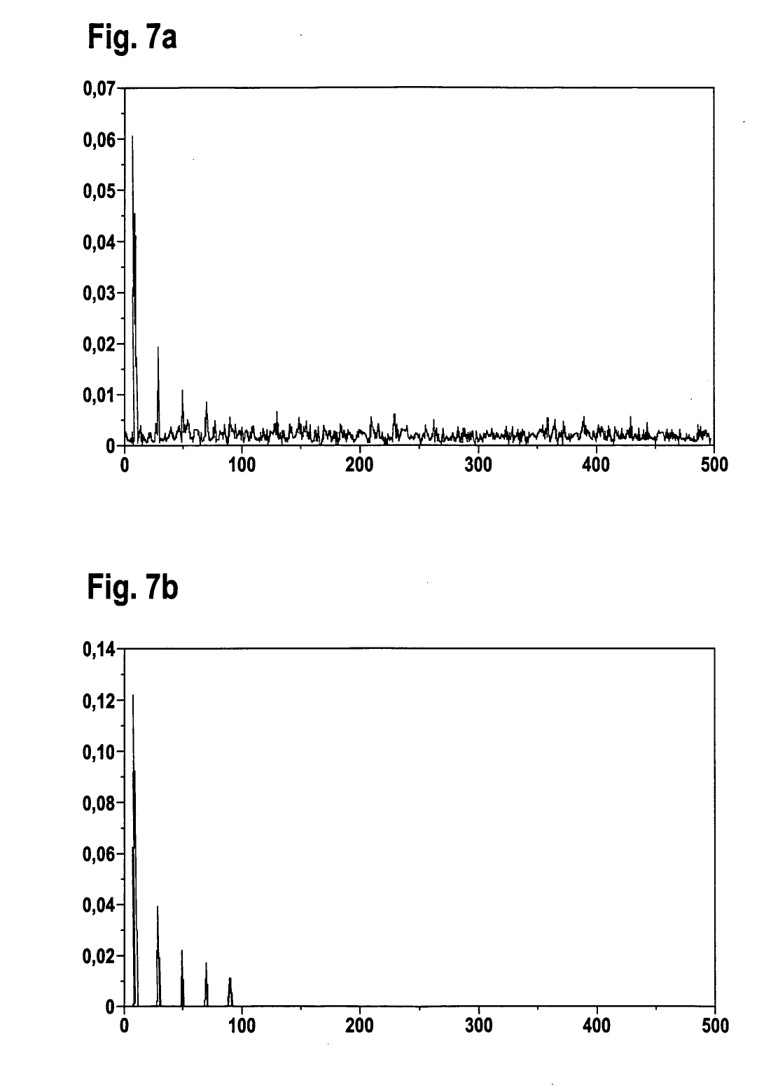

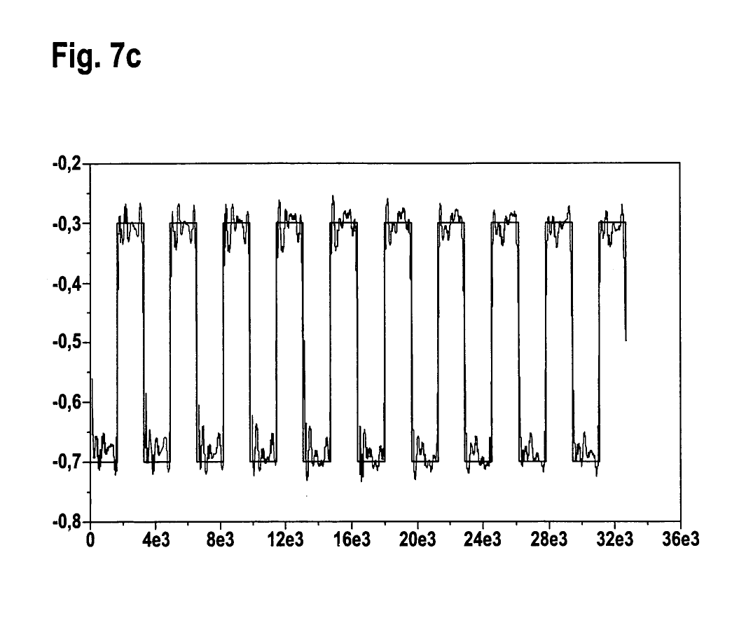

An analysis unit 365 receives the output from the comparator 350 and derives therefrom a jitter spectrum (e.g. as shown in FIG. 7A). A post-processing unit 370 processes the jitter spectrum to identify the deterministic jitter components in the jitter spectrum and accordingly filters the jitter spectrum to substantially eliminate all other components in the jitter spectrum except the identified deterministic jitter components (e.g. as shown in FIG. 7B). The post-processing unit 370 then further allows deriving a jitter modulation signal 380 (representing a deterministic jitter signal modulated on the signal 330) by transforming the filtered identified deterministic spectral components into the time domain. Further analysis on the jitter modulation signal 380 can then be made, e.g. determining amplitude, symmetry, rise/fall time, over/undershoot, etc.

In case of the pure sinusoidal jitter 60 modulated onto the random digital data signal in FIG. 1, the jitter modulation signal 380 of FIG. 3 will represent such sinusoidal jitter signal (subject to more or less distortion as dependent on the processing limitations). It is needless to say that the sinusoidal jitter shape 60 can be replaced by any other (e.g. analog) modulation waveform that can be equivalently extracted with the described method from the data signal 330 in terms of a respective signal 380.

Pure sinusoidal jitter (as shown in the example of FIGS. 1-2) rarely occurs in reality. Typically, real systems show intrinsic random jitter caused by thermal and scattering noise potentially mixed with deterministic jitter as a result from design errors. Since it is the result of many different uncorrelated contributors the intrinsic random jitter generally shows up with a Gaussian distribution. An example where sinusoidal jitter 460 and random jitter intrinsically generated or artificially injected is mixed to form the composite jitter signal 400 is shown in FIG. 4.

As long as the peak-to-peak amplitude of the sinusoidal jitter 460 (dotted line) does not substantially exceed the rms value of the random jitter, the distribution of the composite jitter in the Jitter Histogram 450 still shows up with a bell like distribution that makes separation of sinusoidal and random jitter difficult.

When random and sinusoidal jitter are mixed and the sinusoidal jitter 460 does not exceed the random jitter by far, the error signal 470 generated by sampling in the sampling point 20 (here: crossover point of the transitions) again shows up with a periodic modulation of the error density. The difference to the pure sinusoidal jitter (as depicted in FIG. 1) is that now the negative portion of the sinusoid also generates errors but with smaller density than during the positive portion. Therefore the waveform shape of the sinusoidal jitter 460 gets transferred in a similar way into the error signal 470 and can be extracted e.g. by frequency selective filtering.

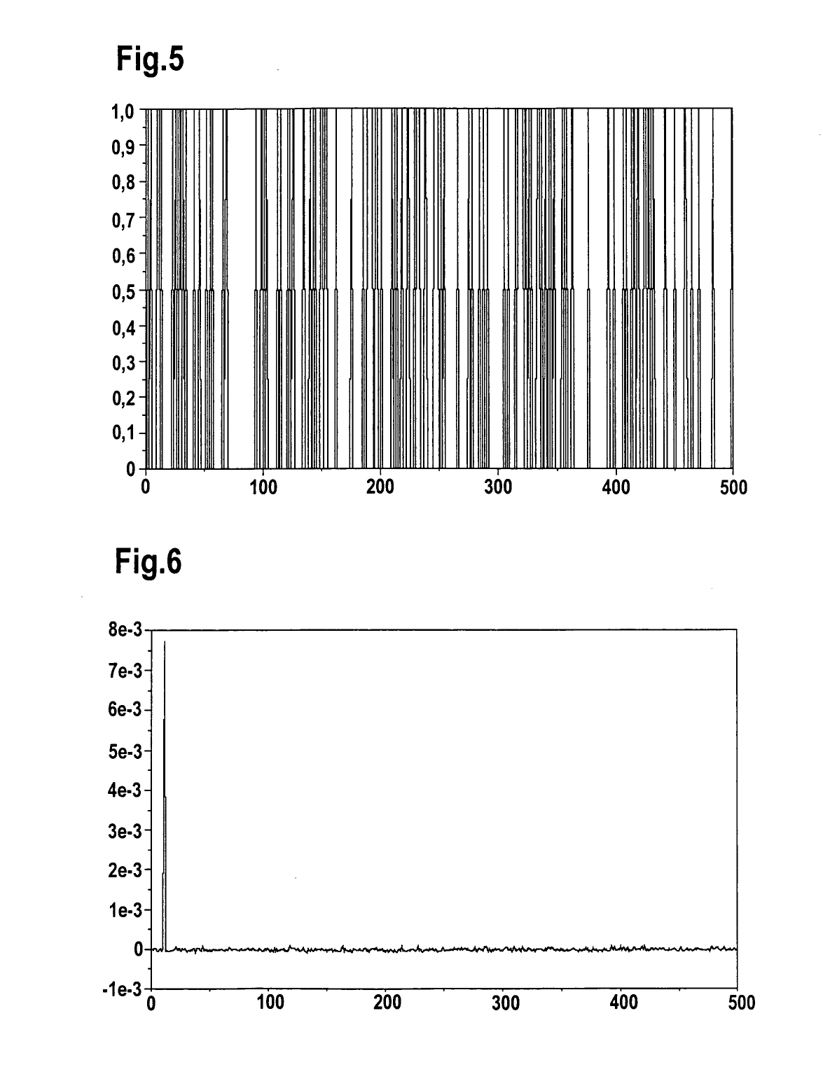

FIG. 5 shows a simulated error signal 470 caused by sinusoidal and random jitter. The periodicity or modulation waveform shape in the error density is hardly visible and the signal appears to have a random character.

FIG. 6 shows the result of the respective simulation with sinusoidal jitter 460 mixed with random jitter to form the signal 400 as of FIG. 4, with the frequency of the sinusoidal modulation 460 appearing as a peak.

The error signal 470 contains all of the information of the original jitter modulation waveform 400 that is the sum of the deterministic waveform 460 and the random jitter. Since a broadband noise signal (here the random jitter) represents a continuous flat power density spectrum, the energy is equally distributed over a wide range of frequencies and thus is typically small in magnitude in a narrow section of the spectrum. In contrary when a periodic signal (here the deterministic jitter) is contained in a broadband noise signal the power density of the periodic signal is strongly concentrated in few (typically equidistantly spaced) discrete lines. Therefore, it is possible to extract the deterministic portion of the jitter modulation waveform 460 by frequency selective filtering that emphasizes the deterministic content and suppresses the random content of the total jitter modulation in the signal 400.

Therefore, when filtering is applied to the jitter spectrum (as e.g. of FIG. 7B), it is possible to extract the deterministic jitter modulation waveform with only minimal distortion compared to the original shape.

FIGS. 7A-7C illustrate an example, wherein instead of sinusoidal (as in FIG. 4) a rectangular jitter modulation 460 occurs. Accordingly, the jitter spectrum in FIG. 7A shows a plurality of distinctive peaks resulting from such deterministic rectangular jitter modulation 460.

Such deterministic spectral components can be identified in the jitter spectrum by applied adequate peak identification algorithms as well-known in the art as well as by using the human eye or combinations of both. Typically, threshold values may be applied, and the spectral components are identified when exceeding the threshold values. A-priori knowledge on the periodicity of an expected jitter modulation signal can be used to identify the deterministic spectral components at expected frequencies taking into account particularly harmonic frequencies belonging to a fundamental frequency of the expected jitter modulation signal. Search algorithms may be applied on the spectral components of the obtained jitter spectrum to identify spectral peaks that follow a given pattern or sequence on the frequency axis. Spectral components with substantially non-random energy content, with energies exceeding a certain value, at specific known frequencies, following a given sequence of pattern, in a certain frequency band, etc. may be selected. Other peak identifying algorithms are also disclosed e.g. in WO-A-00/77674.

In case that plural jitter modulation signal are present, determined deterministic spectral components can be assigned to groups of deterministic spectral components, wherein each group of deterministic spectral components is related to a different jitter modulation signal. Defining a group of deterministic spectral components can be accomplished by e.g. harmonic relationship, by frequency range, by individual shaping of the spectral component, or by group shaping (e.g. frequency distribution, amplitudes, etc.).

In the example of FIG. 7A, a plurality of deterministic spectral peaks be easily identified (e.g. by applying threshold values and harmonic relationship) in the jitter spectrum. The jitter spectrum can then be filtered accordingly to substantially only show the identified deterministic spectral components as shown in FIG. 7B. Filtering may be provided e.g. by passing only the spectral content at selected frequencies and discarding the others, amplifying only the spectral content at the selected frequencies, attenuating the spectral content at the not selected frequencies, using low pass, band pass or multi-passband rake/comb filtering, etc.

The jitter modulation signal 460 can derived from the filtered jitter spectrum of FIG. 7B by transforming the filtered identified one or more deterministic spectral components into the time domain. FIG. 7C shows the thus derived together with the ‘original’ jitter modulation signal 460. It is clear that due to the omission of higher frequency spectral components, the derived jitter modulation signal 460 deviates from the ‘original’ rectangular shape.

An improvement of the result shown in FIG. 7C is possible by processing a higher number of relevant sampling points as used for the simulation. Further improvement can be achieved by performing the filtering with less bandwidth per selected component to avoid the leakage of random components into the passband for the deterministic component. Additional improvement is possible by discarding less of the deterministic components by using a more sophisticated deterministic peak detection.

The fact that the spectral density of the random portion gets distributed over many frequencies while the spectral components of the sinusoidal portion stays concentrated in a single line significantly enhances the detection of spurious deterministic jitter components deeply buried in random jitter. Thus, even small sources of deterministic jitter can be identified.

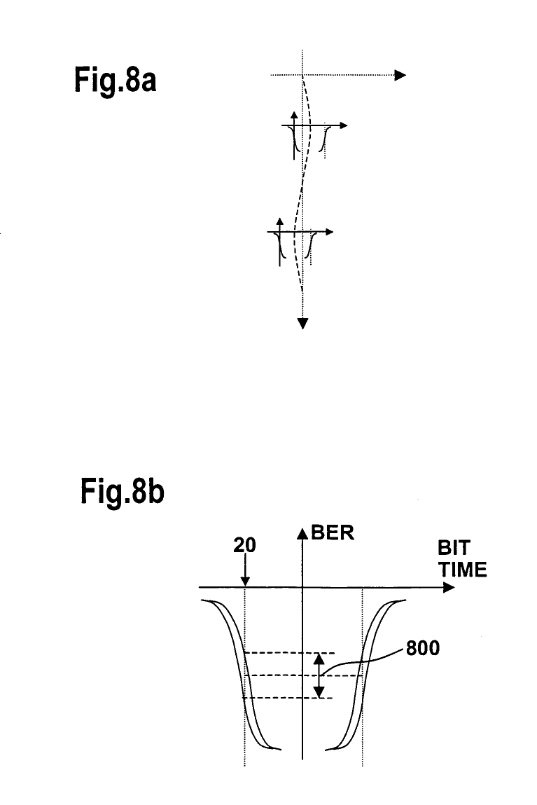

The influence of the position of the sampling point 20 is explained schematically in more detail in FIGS. 8A and B. The distribution of a composite jitter modulation signal consisting of random and sinusoidal jitter on the error rate can be perceived as a sinusoidally shifted Gaussian distribution. This means also that a virtual purely random BER curve is moving sinusoidally left and right on the bit time axis (x-axis in FIG. 8B) due to the sinusoidal component. Therefore, the depth of error density modulation 800 depends on the steepness of the BER curve at the strobe point (the sampling point 20) provided the sinusoidal component is small. From this consideration follows that the optimum sensitivity can be obtained with the sampling point 20 offset by 0.5 UI (UI=Unit Interval) from the data eye center (as shown in FIGS. 1 and 4) or respectively from the center of gravity of the jitter histogram.

The aforedescribed ways to analyze composite jitter containing deterministic (periodic) and random jitter and to extract the underlying deterministic waveform (and e.g. its key parameters such as amplitude and frequency), has been shown particularly useful for design validation and debugging when the sources of the deterministic portions are unknown. However, the extraction of the modulation waveform and, for example, the extraction of the deterministic jitter amplitude might also be of great value for production testing particularly as long as the influence of process variations on the design is not optimized.

In case, however, when it is already known or expected that a problem caused by deterministic jitter of a well-known frequency may exist, a pass/fail test might be provided useful e.g. for production testing. A typical case might be e.g. when process variations or other manufacturing defects result in jitter crosstalk from a known source. Such pass/fail test might be applied in a production test-flow to test for the occurrence of such faults for the deterministic jitter. In case a known deterministic jitter of a given waveform exists, a pass/fail test (e.g. on the deterministic jitter modulation amplitude) might be provided e.g. for production testing.

The random jitter might be calculated from the total jitter and the deterministic jitter extracted as described above. The random jitter might also be subject to a pass/fail test provided for production testing.

The method described above may be applied to any data or clock signal that is not necessarily generated by a device under test 300 as described in FIG. 3 but may be generated in any other way such that jitter is generated that can be analyzed.

1. A method for providing a jitter analysis for a signal, the method comprising the steps of:
(a) filtering a jitter spectrum derived from the signal, so that the filtered jitter spectrum substantially only comprises one or more deterministic spectral components identified as being expected to result from a deterministic jitter component in the signal resulting from a deterministic and non-random cause,
(b) deriving a jitter modulation signal by transforming the filtered identified one or more deterministic spectral components into the time domain, wherein the jitter modulation signal represents a deterministic jitter signal modulated on the signal.

2. The method of claim 1, further comprising—prior to the step of filtering—at least one of the steps:
deriving the jitter spectrum from the signal,
identifying the one or more deterministic spectral components in the jitter spectrum.

3. A method for providing a jitter analysis for a signal, the method comprising the steps of:
(a) deriving a jitter spectrum from the signal,
(b) identifying one or more deterministic spectral components in the jitter spectrum, wherein each identified deterministic spectral component is expected to result from a deterministic jitter component in the signal resulting from a deterministic and non-random cause,
(c) filtering the jitter spectrum so that the filtered jitter spectrum substantially only comprises the identified one or more deterministic spectral components,
(d) deriving a jitter modulation signal by transforming the filtered identified one or more deterministic spectral components into the time domain, wherein the jitter modulation signal represents a deterministic jitter signal modulated on the signal.

4. The method of claim 1, wherein the jitter spectrum represents the spectral components of jitter determined for the signal, preferably in the frequency domain.

5. The method of claim 1, wherein the step of identifying the one or more deterministic spectral components in the jitter spectrum comprises at least one of the steps:
applying one or more threshold values, wherein spectral components are identified when exceeding one or more of the threshold values,
evaluating harmonic frequencies belonging to one or more fundamental frequencies,
identifying spectral peaks following at least one of a given pattern and a sequence on the frequency axis,
using a-priori knowledge on the periodicity of an expected jitter modulation signal to identify the deterministic spectral components at expected frequencies taking into account particularly harmonic frequencies belonging to a fundamental frequency of the expected jitter modulation signal,
applying a search algorithm on the spectral components of the obtained jitter spectrum to identify spectral peaks that follow a given pattern or sequence on the frequency axis,
selecting of spectral components with substantially non-random energy content,
selecting of spectral components with energies exceeding a certain value,
selecting of spectral components at specific known frequencies,
selecting of spectral components following a given sequence of pattern,
selecting of spectral components in a certain frequency band.

6. The method of claim 1, wherein the step of identifying the one or more deterministic spectral components in the jitter spectrum comprises a step of:
assigning one or more of the determined deterministic spectral components to one or more groups of deterministic spectral components, wherein each group of deterministic spectral components is related to a different jitter modulation signal.

7. The method of the claim 6, wherein the step of assigning comprises at least one of the steps:
defining a group of deterministic spectral components by harmonic relationship, wherein the determined deterministic spectral components in that group have harmonic frequencies belonging to a fundamental frequency,
defining a group of deterministic spectral components by frequency range, wherein the determined deterministic spectral components in that group have frequencies within that frequency range,
defining a group of deterministic spectral components by individual shaping, wherein each determined deterministic spectral component in that group has a given shaping,
defining a group of deterministic spectral components by group shaping, wherein the determined deterministic spectral components in that group have a given shaping determined by at least one of: frequency distribution, amplitude.

8. The method of claim 1, wherein the step of filtering comprises at least one of the steps:
passing only the spectral content at selected frequencies and discarding the others,
amplifying only the spectral content at the selected frequencies,
attenuating the spectral content at the not selected frequencies.

9. The method of claim 1, wherein the jitter spectrum is derived by the steps of:
deriving an error signal, preferably a binary error signal, from the signal,
deriving the jitter spectrum from the error signal, preferably by providing a transformation into the frequency domain.

10. The method of the above claim 1, wherein the error signal is derived by:
comparing the signal with a reference signal at a plurality of different timing points.

11. A method for providing a jitter analysis for a signal, the method comprising the steps of:
(i) receiving a plurality of error values, each error value being associated with one of a plurality of successive timing points, and each error value being derived from a comparison of the signal at its associated timing point with a reference signal,
(ii) providing an error signal representing the derived error values relative to their respective timing points, and
(iii) providing a spectral analysis in order to derive the jitter spectrum from the error signal.

12. The method of the above claim 11, wherein the step (i) comprises a step of:
deriving each error value being from a comparison of a result of a detection for a transition occurring in the signal at its associated timing point with the reference signal.

13. The method of claim 11, further comprising prior to step (i) the steps of:
providing, at each one of the plurality of successive timing points, a detection for a transition occurring in the signal at that timing point, and
for each one of the plurality of successive timing points, comparing a result of the detection with the reference signal and deriving an error value there from.

14. The method of claim 11, comprising at least one of the features:
step (iii) comprises a step of applying a Fourier-Analysis to the error signal;
each error value represents a matching information between a detected transition or non-transition and an expected transition or non-transition for the respective timing point;
the error signal represents the plurality of the derived error values, each error value being associated with its respective timing point;
the error signal represents the variation of the error values over the time or any other scale derived from the timing points.

15. The method of claim 11, comprising at least one of the features:
the timing points are selected in ranges wherein transitions are likely;
the timing points are selected substantially in the middle of such ranges wherein transitions are likely under the influence of jitter;
transitions in the signal are related to a reference signal having a reference frequency, a distance between successive timing points is derived from the reference frequency.

16. The method of claim 1, wherein the jitter spectrum is derived by the steps according to claim 11.

17. The method of claim 1, further comprising a step of evaluating a quantitative presence of at least one of: at least one deterministic spectral component and at least one jitter modulation signal in the signal.

18. The method of claim 17, further comprising a step of providing a pass/fail test by comparing the evaluated quantitative presence with a given threshold value.

19. The method of claim 18, wherein the pass/fail test fails, if the evaluated quantitative presence exceeds the given threshold value.

20. The method of claim 1, wherein the reference signal is one of:
an expected signal substantially representing the signal expected to receive,
an expected signal substantially representing a data content of the signal expected to receive,
a signal derived from the signal,
a digital signal derived from the signal,
a constant signal,
an arbitrary test signal, preferably at least one of:
a signal independent of the digital data signal,
a signal unrelated to data content of the digital data signal,
a signal non-correlated to the digital data signal,
a signal with no deterministic relationship with the digital data signal,
a signal independent of the digital data signal,
an arbitrary test value,
a fixed logic value, preferably one of a logic HIGH and a logic LOW signal,
one logic level of the digital data signal,
a pseudo random binary sequence PRBS,
an alternating signal,
a signal of alternating logic values, preferably alternating between a logic HIGH and a logic LOW signal.

21. A method for providing a jitter analysis for a signal to be measured, the method comprising the steps of:
providing, at each one of a plurality of successive timing points, a detection for a transition occurring in the signal at that timing point,
for each one of the plurality of successive timing points, comparing a result of the detection with a reference signal and deriving an error value there from,
providing an error signal representing the derived error values relative to their respective timing points,
providing a jitter modulation waveform analysis for the error signal in order to extract the jitter modulation waveform from the error signal.

22. The method of claim 1, wherein the signal is one of: a digital signal, a digital signal having transitions between logical levels, an analog signal.

23. The method of claim 1, further comprising a step injecting auxiliary jitter, preferably random jitter of high bandwidth or sinusoidal jitter of known frequency, to the signal.

24. A software program or product, preferably stored on a data carrier, for executing the following method for providing a jitter analysis for a signal, when run on a data processing system such as a computer, said method comprising the steps of:
(a) filtering a jitter spectrum derived from the signal, so that the filtered jitter spectrum substantially only comprises one or more deterministic spectral components identified as being expected to result from a deterministic jitter component in the signal resulting from a deterministic and non-random cause,
(b) deriving a jitter modulation signal by transforming the filtered identified one or more deterministic spectral components into the time domain wherein the jitter modulation signal represents a deterministic jitter signal modulated on the signal.

25. An apparatus for providing a jitter analysis for a signal, comprising:
a filter adapted for filtering a jitter spectrum derived from the signal, so that the filtered jitter spectrum substantially only comprises one or more deterministic spectral components identified as being expected to result from a deterministic jitter component in the signal resulting from a deterministic and non-random cause,
a signal analysis unit adapted for deriving a jitter modulation signal by transforming the filtered identified one or more deterministic spectral components into the time domain, wherein the jitter modulation signal represents a deterministic jitter signal modulated on the signal.

26. The apparatus of claim 25, further comprising:
a spectrum analysis unit adapted for deriving the jitter spectrum from the signal, and
an identificator adapted for identifying the one or more deterministic spectral components in the jitter spectrum.

27. The apparatus of claim 25, wherein the spectrum analysis unit is adapted for executing at least one of the features:
deriving an error signal, preferably a binary error signal, from the signal, and deriving the jitter spectrum from the error signal, preferably by providing a transformation into the frequency domain;
comparing the signal with a reference signal at a plurality of different timing points.

28. A spectrum analysis unit adapted for providing a jitter analysis for a signal, comprising:
a signal generation unit being adapted for receiving a plurality of error values, each error value being associated with one of a plurality of successive timing points, and each error value being derived from a comparison of the signal at its associated timing point with a reference signal, the signal generation unit being further adapted for generating an error signal representing the derived error values relative to their respective timing points, and
an analysis unit being adapted for providing a spectral jitter analysis error signal in order to derive a jitter spectrum from the error signal.

29. A spectrum analysis unit adapted for providing a jitter analysis for a signal, comprising:
a detector adapted for providing, at each one of a plurality of successive timing points, a detection for a transition occurring in the signal at that timing point,
a comparator adapted for comparing, for each one of the plurality of successive timing points, a result of the detector with a reference signal and deriving an error value there from,
a signal generation unit being adapted for generating an error signal representing the derived error values relative to their respective timing points, and
an analysis unit being adapted for providing a spectral jitter analysis for the error signal in order to derive a jitter spectrum from the error signal.

30. The apparatus of claim 26, wherein the spectrum analysis unit comprises:
a signal generation unit being adapted for receiving a plurality of error values, each error value being associated with one of a plurality of successive timing points, and each error value being derived from a comparison of the signal at its associated timing point with a reference signal, the signal generation unit being further adapted for generating an error signal representing the derived error values relative to their respective timing points, and
an analysis unit being adapted for providing a spectral jitter analysis error signal in order to derive a jitter spectrum from the error signal.

31. The apparatus of claim 26, wherein the spectrum analysis unit comprises:
a detector adapted for providing, at each one of a plurality of successive timing points, a detection for a transition occurring in the signal at that timing point,
a comparator adapted for comparing, for each one of the plurality of successive timing points, a result of the detector with a reference signal and deriving an error value there from,
a signal generation unit being adapted for generating an error signal representing the derived error values relative to their respective timing points, and
an analysis unit being adapted for providing a spectral jitter analysis for the error signal in order to derive a jitter spectrum from the error signal.
